(19) United States
(12) Patent Application Publication
(10) Pub. No.: US 2012/0172013 A1
(43) Pub. Date: Jul. 5, 2012

(54) mPulseRadio: An interactive broadcast radio system that enables real-time demographics collection

(76) Inventor: Yul Williams, Upper Marlboro, MD (US)

(21) Appl. No.: 13/035,903

(22) Filed: Feb. 25, 2011

Related U.S. Application Data
(60) Provisional application No. 61/429,176, filed on Jan. 2, 2011.

(51) Int. Cl. H04W 4/00; H04Q 5/22

(52) U.S. Cl. 455/414.1; 340/10.1

(57) ABSTRACT

This invention assists broadcast radio listeners by facilitating their active engagement of on-air content. Listener selected information invokes search processes within a plurality of mediums and results are returned to the listener over prescribed plurality of communications mediums. Broadcasters acquire real-time listener demographic information based on the number of selections received when specific content is aired. Such information is used to assess the popularity of on-air personalities or particular products. The greatest impact of this invention is the combined application of broadcast radio, cellular telephone and the Internet to provide interactivity for listeners. All three mediums are harnessed to make this invention viable. The invention system offers novel capabilities that are not currently possible in modern broadcast radio. This includes the niche broadcast radio area of satellite radio.

The present invention represents a significant set of improvements over the original U.S. Patent and Trademark Office (USPTO) Disclosure 496672 which was disclosed it to the USPTO on Dec. 6, 2001. The Inventor has been actively pursuing development and refinement of the concept and has renamed the improved invention “mPulseRadio” to more accurately describe the invention and suggest the market domains that it addresses. In accordance with 35 U.S.C. §119(e), this application corresponds directly to U.S. provisional application No. 61/429,176 which was filed on Jan. 2, 2011 with the identical title of the present invention.

### BRIEF DESCRIPTION OF THE INVENTION

1. Field of the Invention

This invention relates to converged communications systems for identifying broadcast content to drive distributed information systems, deliver enriched content information to subscribers and facilitate electronic commerce from personal subscriber units. This invention relates to radio broadcast systems that utilize the Radio Data System (RDS) that is widely used in Europe and the Radio Broadcast Data System (RBDS) that is used within the United States that facilitates the transmission of auxiliary information along with audible broadcast content.

2. Prior Art

To my knowledge, there are no known ideas that have been proposed or products created that encompasses the range of functions and capabilities embodied in this invention.

To my knowledge, prior to the present invention, there has not been available, or known, a device for identifying broadcast content in a real-time fashion and providing real-time audience demographics, facilitates the capture of broadcast content selection and enables radio listeners to interact directly with the broadcaster or indirectly to acquire information on specific broadcast content.

U.S. Pat. No. 6,119,167A (Boyle, et. al.) entitled: “Pushing and Pulling Data in Networks”, describes a means of using intermediate computing platforms as a means of improving the efficiency to move data between the client and server systems. The invention system that is the subject of this application, however, requires detailed interaction (unlike said patent) between computer networks, cellular telephone networks and radio broadcast networks in order to service client requests for information. In addition, the retrieved information is provided both to the service subscriber and to the radio broadcast stations to provide real-time demographics for on-air programs. U.S. Pat. No. 6,119,167A makes no claims in the identified functional and operational areas established by this invention.

U.S. Pat. No. 6,748,427B2 (Drossett et. al.) entitled: “System and Method for Providing Measurements of Tracking Events of Radio Broadcast Materials via The Internet” describes a system that requires the capture of broadcast radio and re-broadcast of the on-air content within the Internet medium in order to capture and assess user demographics. The “user terminal” described in said patent is described as a computer with a player that is compatible with the content that is stream-broadcast into the Internet medium. The invention that is the subject of this application, however, does not require the re-broadcast of original radio station broadcast content within the Internet in order to capture listener demographics. In addition, the listener may use any RBDS enabled radio with any cellular phone (with a plurality of wired or wireless local input/output) capabilities to retrieve original broadcast content and information about broadcast content. In addition, listener demographics are captured within the subject invention system in a real-time fashion that are provided to the broadcast radio station using a plurality of means. Lastly, the subject invention system includes additional content types that supersede the music-only content type that is expressed in U.S. Pat. No. 6,748,427B2. The subject invention includes the content types of music, news, emergency broadcast, contests, audience polling and advertisements. In fact, this invention uses all of the established program types defined in the RDS/RBDS standards as well as enhanced types that are unique to this invention.

U.S. Pat. No. 0,206,742A1 (Giaccherini et. al.) entitled: “Advertising Reporting Demographics System” describes a means of measuring the effectiveness of advertisement marketing efforts by making available a free calling service and exposing callers to advertisements prior to connecting the calls to the intending call recipient. This specific patent description and its claims bear no relationship in function, intent or performance to the subject invention system.

U.S. Pat. No. 5,101,267 (Morales-Garza) entitled: “Wide Area Real-time T-V Audience Polling System with Local Area Stations Linked by Satellite” describes a means of polling subscriber television customers to gauge interest in various broadcast content. This methods described in the patent are initiated by the broadcaster. In addition, the said patent requires the implementation of a system of set-top units, satellite communications units and repeater units. Such units or the functionality assigned to them are not required in the subject invention system. The operation described in the subject invention system, moreover, is initiated by the radio listener and demographics information is derived directly from the interactivity between the listener and the listener-selected broadcast content.

U.S. Pat. No. 6,393,471B1 (Kobata) entitled: “Marketing Data Delivery System” describes a means of collecting demographics information on users of Internet systems by installing client-side applications on user machines and performing detailed measurements of content examined from the local hard drive. This specific patent description and its claims bear no relationship in function, intent or performance to the subject invention system.

U.S. Pat. No. 6,701,161B1 (Wendling) entitled: “Multimedia Unit” describes an automobile-based multimedia unit with a removable operating system. The removable operating system is embodied in a tightly coupled cellular phone unit that is required in order for the patent system to perform its intended functionality. The patent system does not perform functions that are expressly claimed in the subject invention system. It does not claim any means of collecting listener information or capturing and conveying listener demographics. As such, the patent system bears no relationship to the subject invention system

U.S. Pat. No. 6,112,064 (Arrowsmith et. al.) entitled: “RDS Radio with Multi-function RDS Button” describes a radio system that support access to the numerous auxiliary data elements provided within an RDS broadcast stream. The patent addresses issues of facilitating the access and manipulation of RDS data, but, it does not claim any means of providing methods to capture, save and access additional services to help the listener acquire supporting information using a plurality of communication mediums. The patent is related to the subject invention system in that it relies on the presence of the RDS/RBDS system on which it bases its functionality. The patent system, however, does not perform functions that are expressly claimed in the subject invention system.

The invention system addresses the needs of broadcast radio listeners to actively engage on-air content. In short, this invention changes the traditional receive-only broadcast radio model into a new and more practical interactive radio platform. Listeners hear aired content and may express interest by selecting it using a plurality of methods which includes a physical button on the listener's radio unit or software application executing on a connected wired or wireless device that links to the listener's radio. Once selected, the requested information causes subsequent search processes to take place within a plurality of mediums that query a range of information services to locate, gather, present and save detailed findings for the listener. Once all of the information is located, ranked and organized, it is then delivered back to the listener over prescribed plurality of communications mediums and to the listener's subscriber account.

As an added benefit, invention-compatible broadcast radio stations receive real-time listener demographic information based on listener requests received when specific content is aired. Such information may be used to assess the popularity of on-air personalities, particular products, or participation interest to call-in contests.

The greatest listener impact that this invention provides is the harnessing of broadcast radio, cellular telephone and the Internet. The utilization of all three mediums make this invention very robust and provides for greater service availability to the listener. The listener's cell phone facilitates the transfer of listener requests from the listener's radio. Listener information requests are wired or wirelessly transferred to the phone. The phone then formats and transmits the requests using a plurality of messaging systems. These messages are received and processed by a clearinghouse server that uses the Internet and other open and private systems to conduct dynamic searches to retrieve the listener's requested information.

The invention system offers novel capabilities that are not currently possible (or published as future capabilities) in modern broadcast radio. This invention is practical for traditional broadcast radio as well as satellite radio mediums.

### SUMMARY OF THE INVENTION

The purpose of the present invention is to enable the broadcast radio listeners to interactively engage aired content in a real-time fashion. The interactive radio system allows listeners to request information about broadcast content as it is broadcast. The content types handled by this invention include all of the established RDS/RBDS program types as well as extended types of contests, audience polling and dynamic advertisements.

A content session is established as a time range that marks the beginning and ending points of a selectable grouping of broadcast content. Each content session is assigned a unique content session identifier. If the listeners make a selection during a content session, that unique identifier is captured and used as a key to guide the other portions of the invention system components in locating, retrieving and presenting the findings to the listener.

The invention was developed for the purpose of empowering the radio listener with the ability to select broadcast content and have information about that content delivered to the listener using a plurality of listener-selected communications modalities. The invention system is personalized for each listener such that the listener is able to control the means of information delivery. An information delivery service accepts all user requests and delivers the requested content in the preferred mode.

In addition to providing interactivity for broadcast listeners, the invention also provides a means of producing real-time demographics of the broadcast audience. Information is collected that indicates the size and particular interests of the audience without specifically exposing to the public the individual listener's personally identifiable information (PII).

In order for the invention to provide the described services, a more granular content description language and content tagging technology is required. This invention advances the prior art of the REDS and the RDS by segmenting content into higher resolution pieces of information that can uniquely identify specific products from a series of broadcast product-oriented commercials. By using the described language, and the encoded content, the invention system can uniquely identify a news story within a newscast segment. The invention system can, moreover, identify specific unique content within the news story as well.

### THE DRAWINGS

FIG. 1: Invention Draft Mockup Listener Platform

FIG. 2: Configuration for mPulseRadio Broadcast Station

FIG. 3: Organizational structure of Content meta-data

FIG. 4: Invention Operational View

FIG. 5: Invention Lifecycle Illustration

FIG. 6: Illustration of Content Session Segmentation

FIG. 7: The Structure of a Fine-Resolution Newscast

FIG. 8: Event Trace representation of Invention Operational Model

FIG. 9: Event Trace Representation of Invention Real-time Demographics Operational Model

FIG. 10: Functional Decomposition of a Participating Listener Platform Unit

FIG. 11: Functional Decomposition of the Clearinghouse Service

FIG. 12: Functional Decomposition of the Information Provisioning Service

### DETAILED DESCRIPTION

Referring now to the drawings:

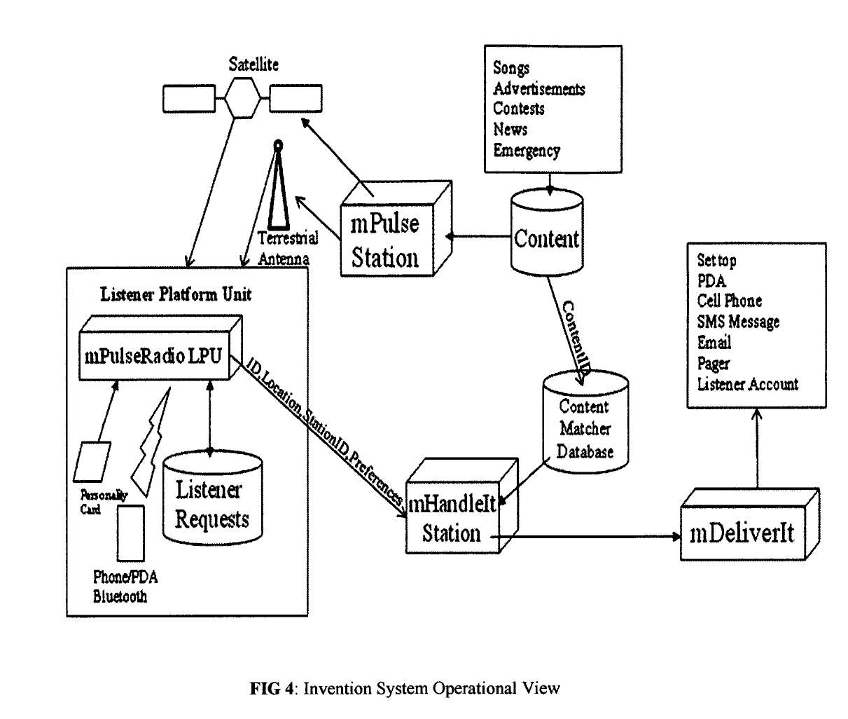

In the illustrated preferred embodiment (FIG. 4), the invention is described by depicting each of the system components and their operational functions, respectively. Although the preferred form of my invention has been herein described, it is to be understood that the present disclosure is made by way of example and that variations are possible without departing from the scope of the hereinafter claimed subject matter, which subject matter I regard as my invention.

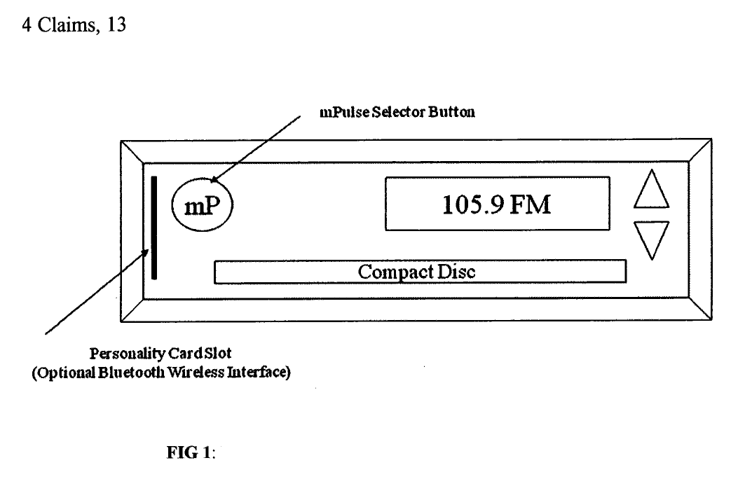

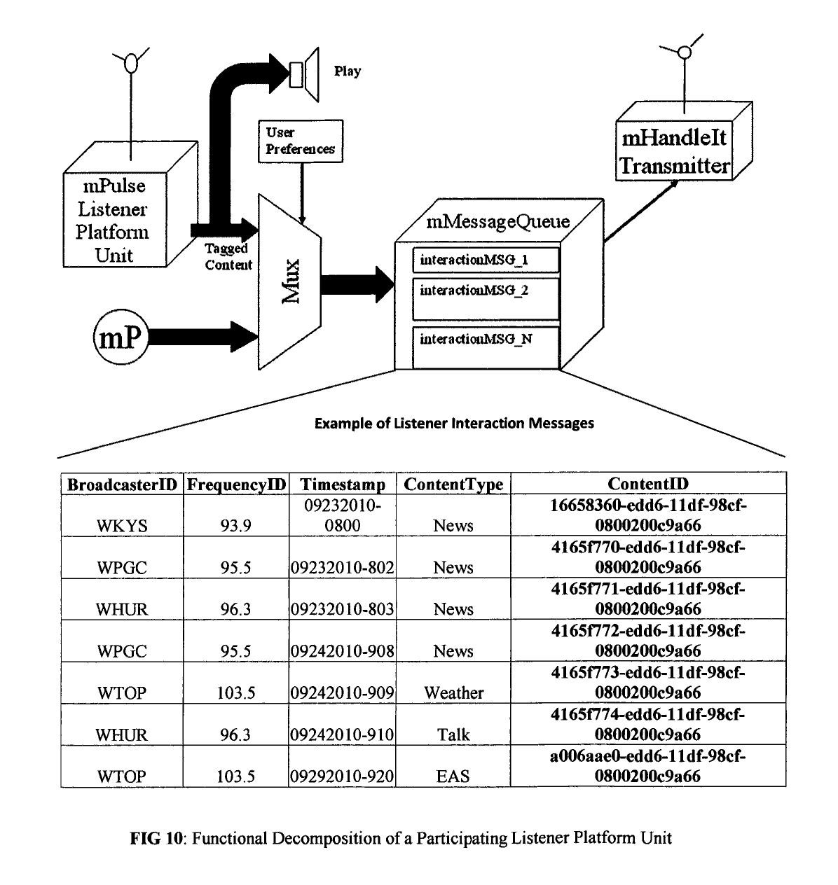

In an alternative embodiment, the listener platform unit (FIG. 10) may be encapsulated as an application that resides within the listener's personal cell phone or other personal platform that is capable of communicating with an RDS/RBDS capable radio. At the request of the listener, the application captures the essential content tags from the listener platform unit in FIG. 1 via a plurality of communications links and formats the listener requests to be conveyed to the system as depicted in FIG. 4.

A standard vehicle radio available in the current marketplace supports the reception of RDS/RBDS encoded information. This information is broadcast by the radio station and received by the listening audience. In FIG. 1, the listener's radio platform appears as a typical radio unit, but it has some enhancements. The unit is augmented with a selector button to facilitate listener requests for information of broadcast content. In addition to the listener platform, there are other components that are necessary to make the entire system work to deliver information to the end user.

Modern radio broadcast stations on the Frequency Modulation (FM) band have the ability to transmit metadata along with the original broadcast content. Using the RBDS and RDS capabilities, listeners can read the names of the radio personalities or the names of songs as music is aired on the radio front panel. FIG. 3 illustrates how the broadcast radio station prepares and encodes the content before it is transmitted over the airwaves. The invention system uses the RDS/RBDS protocol to include content that facilitates the selection of aired content by the listener by generating Listener Interaction Messages to capture listener interests.

FIG. 3 illustrates the composition of a listener interaction message that is composed each time a listener makes a selection of desired content during a live content session. The ListenerPlatformID identifies the requesting radio identifier that is associated with the listener. This information allows the invention system to route any retrieved information back to the requesting listener. The BroadcasterID is a unique identifier for the radio station that aired the content of interest. The FrequencyID captures the radio frequency of the radio station that transmitted the content of interest and serves as a redundancy check on the broadcasting radio station identity. A Timestamp indicator is included to capture the time of day when the aired content was selected by a listener. The ContentType may be any of the RDS/RBDS Program Types (PTY) or an extended type provided by the invention system. A Content Identifier (ContentID) is generated as a Globally Unique Identification (GUID) number for each content session as detailed in FIG. 7. The Listener Platform Unit identifier is also encoded within the Listener Interaction Message to uniquely identify the requesting listener for each transaction.

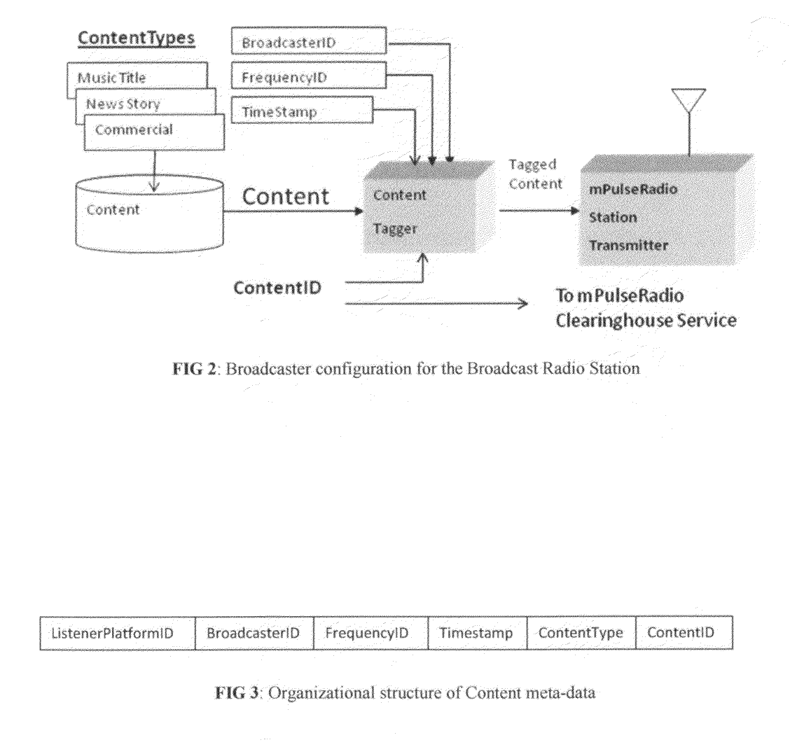

FIG. 2 shows a radio broadcast station employing the invention system and illustrates the type of information that is available within the broadcast content. While this invention may use all of the existing RDS/RBDS program types, this information may be enhanced to exhibit finer resolution than is currently available (as depicted in FIG. 7) within the defined RDS/RBDS systems. Examples of such information include specific stories within newscasts, contest entry registration and dynamic audience polling.

If the broadcast station identifier and the selected content are aggregated and made a part of the listener interaction messages, the listener is not required to remember these details of content-station pairings. In addition, the broadcaster is given market credit for introducing the listener to the product as a direct result of the listener's interest. The tagged content may be broadcast in a plurality of electronic mediums as shown in the example illustration in FIG. 4.

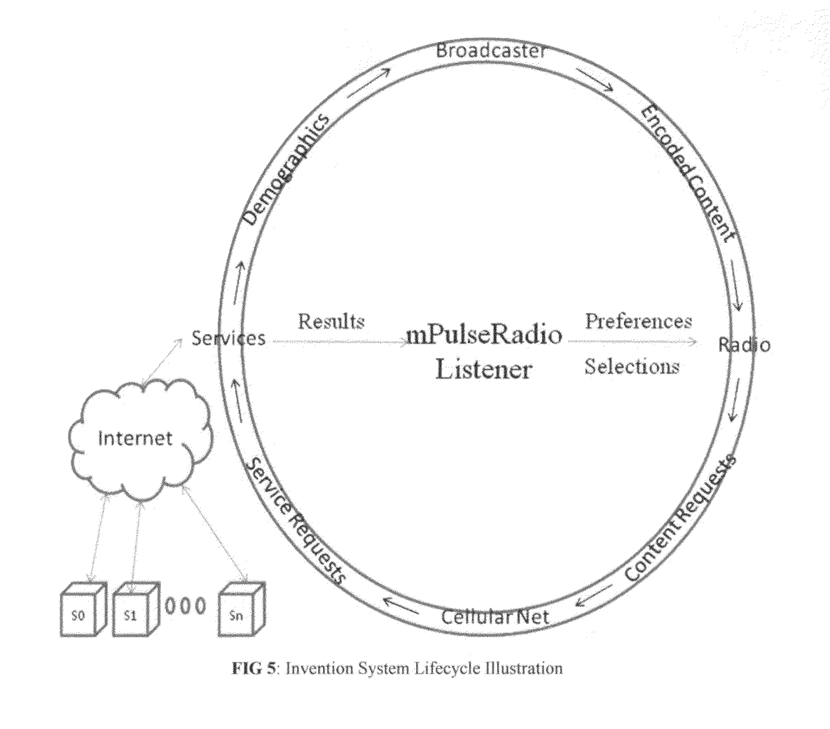

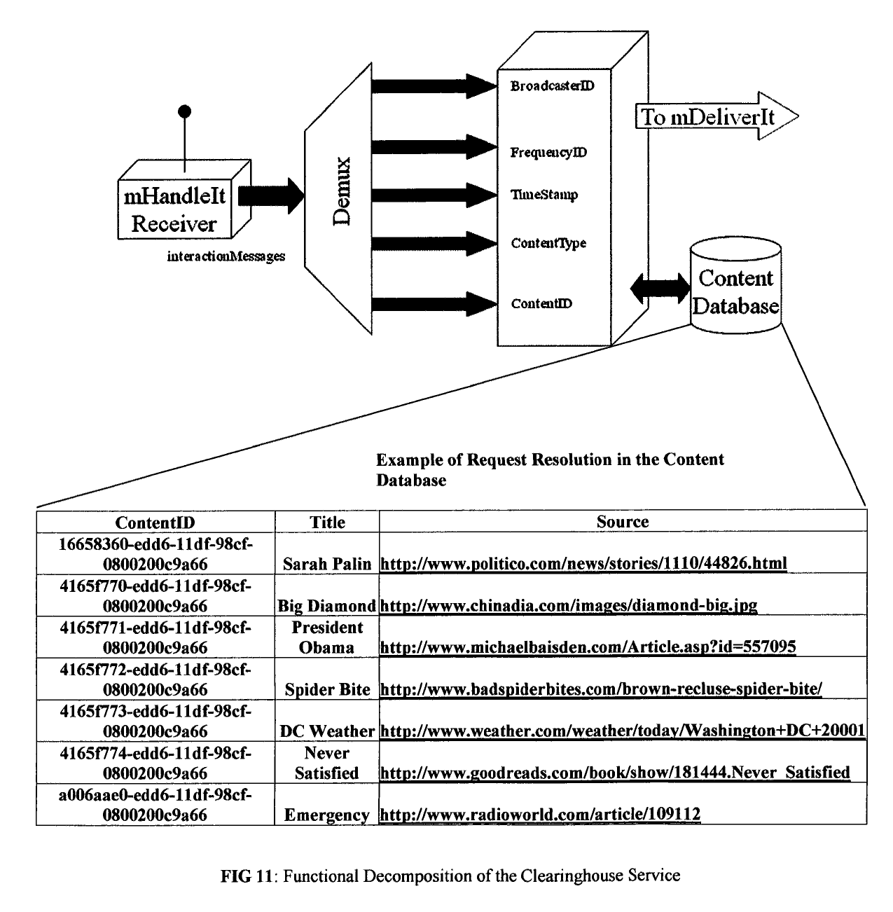

As depicted in FIG. 4, the listener makes content selections. This information is stored in the listener's platform unit. The listener's platform unit is linked (wired or wirelessly) to the listener's personal communications device (i.e. cell phone). The cell phone executes an application (FIG. 13) that takes all of the listener selections from the listener's platform unit and sends them all via a messaging service to an information handler server. The requests are received and processed using Internet connected servers to retrieve news, background information, product details, contest rules and music information. Once each request is completed, the listener results are transmitted to a delivery server that sends the requested information back to the listener as specified in the listener profile. The resulting information may be sent back to the listener in real-time or delayed fashion using a plurality of media, modes and services. These may include popular services including: Short Message Service (SMS), Multimedia Message Service (MMS), email, voicemail and hyperlinks to websites of interest. This information is concurrently sent to the listener's subscriber account to subsequent access by the listener. This entire “lifecycle” is depicted in FIG. 5 of the provided drawings. In FIG. 10, a decomposition of the listener platform unit illustrates how the listener request is translated into interaction messages and forwarded to the clearinghouse unit (shown in FIG. 11) for lookup and information retrieval.

As detailed in FIG. 4, the broadcast radio station encodes the broadcast content immediately before it is aired. At the time of encoding, the content identifier is transmitted to the Content Matcher Database which is also depicted in FIG. 4. Once the listener makes a selection on the listener platform unit, an interaction message is generated that contains the unique content identifier. When the interaction message is captured by the clearinghouse system, the content identifier is used to match the original content. The interaction message also contains information about the broadcaster and listener. Using this information, the listener is delivered the requested information and the specific broadcaster that aired the selected content may receive the demographics information to gauge its effectiveness in reaching and appealing to its audience.

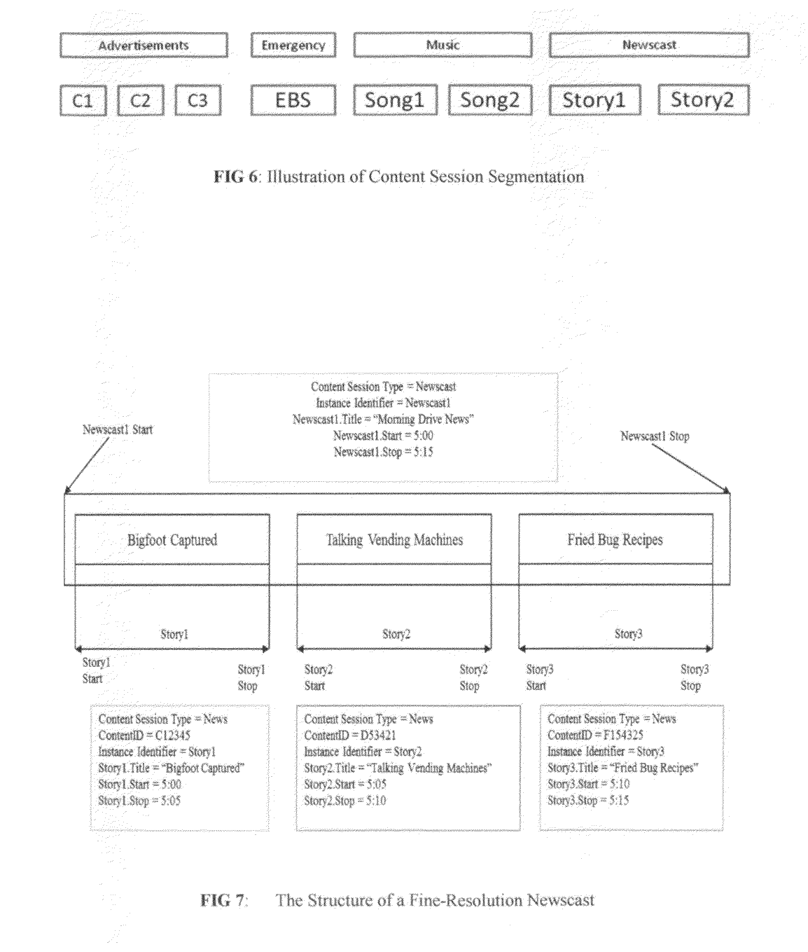

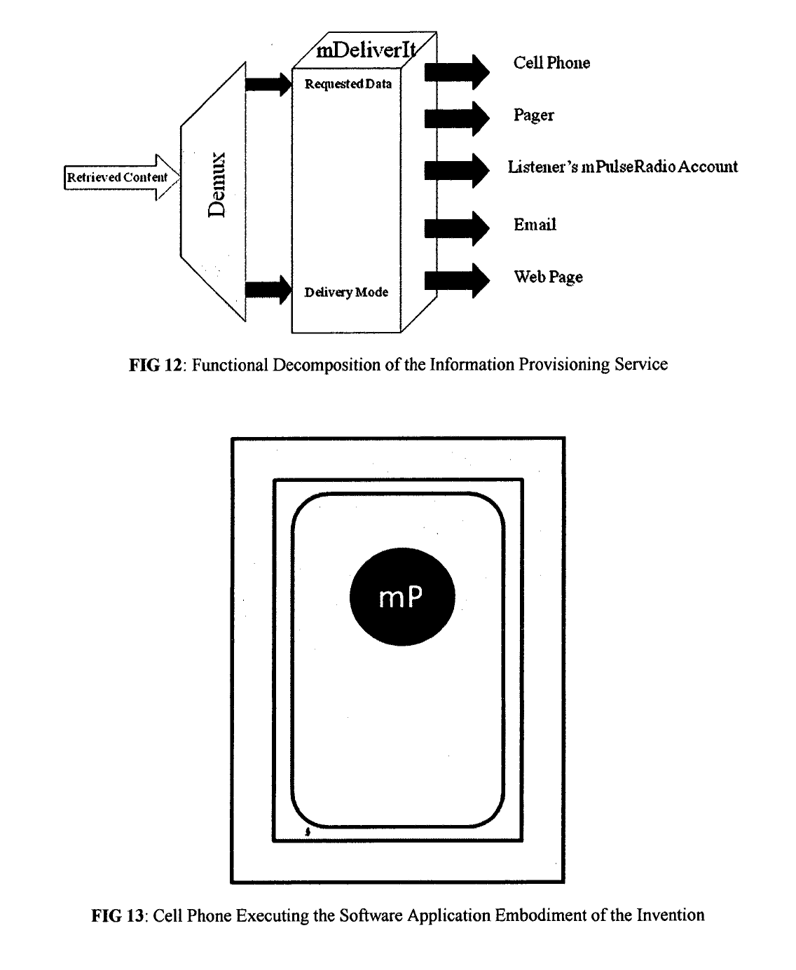

The invention provides a unique method to combine the use of broadcast medium with the cellular and Internet capabilities in order to deliver a plurality of services to the radio listener. Conventional radio has no means of accepting listener input in an interactive and real-time manner as detailed in FIGS. 5 and 6, respectively. In FIG. 12, the interaction messages are received and cross-correlated with stored content identifiers to match the listener's requests with the information that was broadcast by the radio broadcast station.

As illustrated in FIG. 5, this invention delivers real-time demographic information directly back to the invention-enabled broadcast radio station. The station operators become instantly aware of their respective audiences, their specific interests and their length of time the listeners tune into specific broadcast shows. FIG. 14 shows how the results of the listener requests are parsed and delivered to the listener's account and a plurality of other communications channels. In addition, FIG. 14 shows how the demographic information derived from all measured listener requests are provided back to the participating broadcast radio stations.

FIG. 5 illustrates the complete lifecycle of the invention system. The system is more than the Listener platform. It includes hardware components, application code and a collection of complex processes that must work seamlessly to provide a level of listener interactivity that has never been achieved in the radio industry.

The operation of the invention system is depicted in FIG. 4. The key operational features of the system include the content database, the invention compatible radio broadcasting stations (FIG. 2), invention enabled listener platform units, an electronic clearinghouse component and the information delivery channels.

In addition, FIG. 5 illustrates how this invention converts every invention-enabled radio receiver into a Point of Sale (POS) terminal. In addition to merely delivering information to the listener, the listener may optionally link his respective invention-enabled receiver unit to financial accounts to facilitate pre-authorized direct buying opportunities from their respective vehicles.

FIG. 6 shows how this invention expands the level of granularity of current broadcast content such that listener information requests may be facilitated at a resolution level that allows for the selection of high resolution content within a broadcast content segment.

As shown in FIG. 7, the news segment of a broadcast, for instance, may consist of 3 “stories”. Using RDS/RBDS systems, the listener's radio panel display reads: “News”. Each content session represents a specific type of broadcast content. The sessions are composed of instances of the broadcast content type. Using this approach, each instance may be uniquely identified and any listener interest may be focused on the instances. A fine-resolution message on the radio panel, by comparison to low resolution message on a typical RBDS panel, may read the same but the underlying capture of listener requested information is performed at a higher level of resolution as illustrated in FIG. 7. This high resolution capture capability is enabled using interaction messages that capture the exact time that the listener makes a selection and correlates the event to the unique identifier representing the on-air content. Using such an approach, the listener request is made more accurate than current technologies make available.

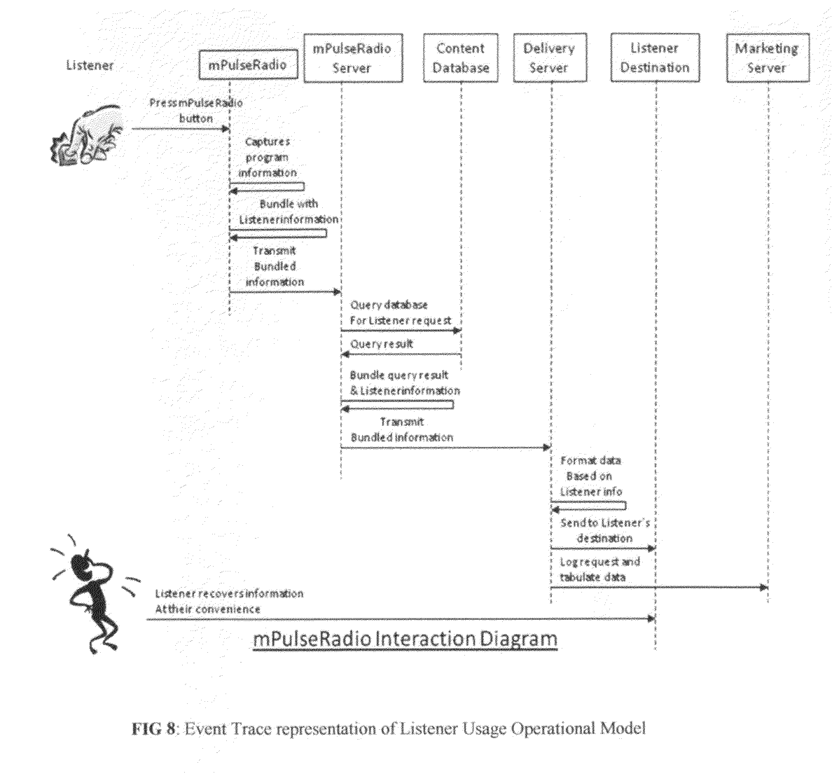

The operational use scenario of the invention system is illustrated with the use of system event traces in FIG. 8. The event trace model details the typical listener-driven use scenario and the manner in which all of the system components interact and share information to provide the resultant enhanced information to the requesting listener.

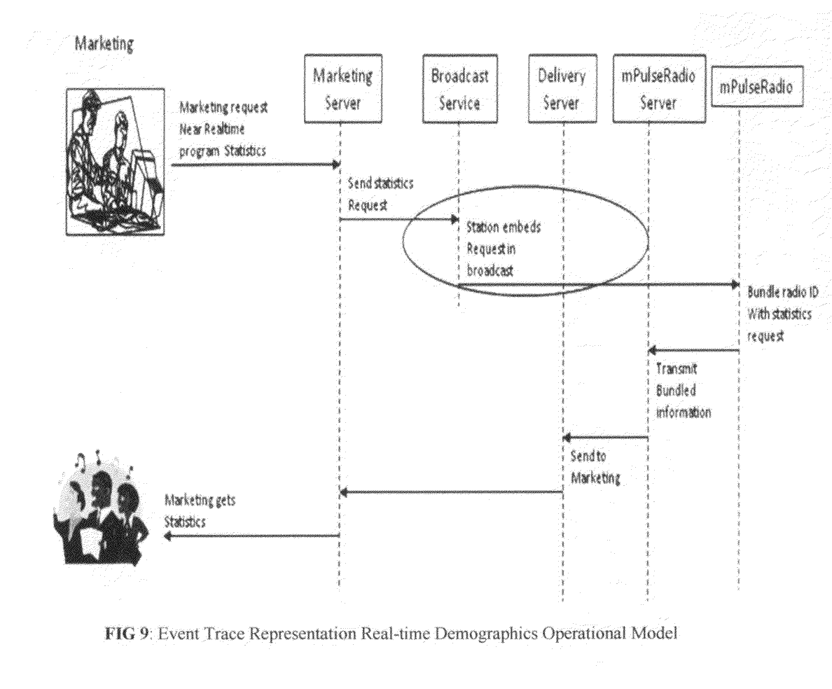

The operational use scenario of the invention system is illustrated with the use of system event traces in FIG. 9. The event trace model details the typical invention enabled broadcast radio station use scenario and the manner in which all of the system components interact and share information to provide the resultant real-time audience demographic information to the invention enabled radio broadcast station.

The components of the invention system illustrated in FIG. 4 provide detailed insights into the manner in which listener requests are captured, processed and delivered to the listener and to the invention enabled radio broadcast stations.

The content database component in FIG. 4 holds all of the songs, retail advertisements and radio station-sponsored promotions. All of this content is properly encoded such that the other components within the system may correctly interpret and act upon them. This database content tags exists in two places within the invention system. The broadcast radio station has a copy that it uses to select content for broadcasting. The Information Clearinghouse Service system shown in FIG. 11, maintains a copy that is used as match criteria for the listener requests.

The invention enabled broadcasting stations in FIG. 4 transmit the content via conventional means or by satellite. This information may be targeted to local audiences through the traditional Radio Frequency (RF) means. This method reaches audiences in well-defined local listening area. The overall reception range is a function of both the transmitting power of the radio station as well as the sensitivity of the listener platform units in the listening area. When the broadcast is transmitted via satellite, the audience may be nationally targeted. This is due to the tremendous coverage area afforded by satellite technology. Several new digital satellite radio companies have established a nation-wide listener base for satellite radio. As depicted in the FIG. 4, the invention system is compatible with a plurality of broadcast mediums that include satellite and radio frequency broadcaster stations.

The invention enabled listener platform units shown in FIG. 4 are positioned in the listener vehicles are designed to receive the broadcasts of conventional radio stations as well as the invention enabled broadcast radio station broadcasts. The listener may use the listener platform units to respond to radio broadcasts. The listener may request information about broadcast content by depressing the listener platform unit selector button on the front panel of the listener platform unit. The request is transmitted from the listener platform unit via plurality of wireless communications. The listener's platform unit generates listener interaction messages, converts them into a listener platform unit request message and transmits it to the listener's cell phone to deliver the requested information to system information clearinghouse component.

As shown in FIG. 1, the listener may establish a profile that is used by the invention system to refine the manner in which the requested information is delivered. The listener may request the information be delivered over a single means or through multiple channels. This personalization of information delivery is handled through a listener personality card, or by electronic download (e.g. Bluetooth link) to the listener's platform unit. Regardless of the form of the personality information, it is loaded into the listener platform unit and serves to guide the information delivery process. Each message that is generated from the listener platform unit may contain optional information, including the personality information that is used by the rest of the invention system. This option is enabled or disabled by the listener during the system setup.

The information clearinghouse service receives all of the listener requests. When the messages arrive, they are parsed and the tags are matched in the content database such that the requested information may be forwarded to the listener. The personality information is also parsed to retrieve the listener preferences to guide the information delivery process. All of this information is packaged for the user and sent to the service that delivers the requested information through the preferred delivery channels as show in FIGS. 9 and 10. The information clearinghouse service in FIG. 11 also records the requests from all of the users based on the invention enabled broadcast radio station and requested information. This is done to build a demographic snapshot of listener interests.

Finally, the packaged information is queued for final delivery in the preferred delivery channels. This is performed by a component called information delivery service (see FIG. 4). It is responsible for insuring accurate and timely delivery of information to the listener using the listener-supplied preferences.

I claim:

1. A system that facilitates listener interaction with the broadcast content, by making selections from the front panel of the respective Listener Platform Unit (i.e. broadcast receiver) or a plurality of communications devices enabled with software applications to capture the listener selections and convey them to the information clearinghouse service for request processing. This includes personal cell phones, wireless gaming platforms and personal computing platforms.
A means of capturing real-time audience demographics by monitoring, counting and correlating the listener interaction messages associated with selected broadcast content and conveying audience demographics to the broadcaster in a near real-time fashion.
The definition of a Listener Platform Unit that communicates requested broadcast radio content information with the listener's cell phone using both wired and wireless interfaces.
A means of converting automobile radios into personal Point of Sale (POS) stations that facilitate electronic commerce transactions based solely on broadcast radio content
